(19) United States
(12) Patent Application Publication
(10) Pub. No.: US 2019/0074522 A1
(43) Pub. Date: Mar. 7, 2019

(54) CATALYST ELECTRODE LAYER, MEMBRANE-ELECTRODE ASSEMBLY, AND FUEL CELL

(71) Applicant: TOYOTA JIDOSHA KABUSHIKI KAISHA, Toyota-shi (JP)

(72) Inventors: Nobuaki MIZUTANI, Toyota-shi (JP); Hiroo YOSHIKAWA, Toyota-shi (JP); Tsunemasa NISHIDA, Nagoya-shi (JP)

(73) Assignee: TOYOTA JIDOSHA KABUSHIKI KAISHA, Toyota-shi (JP)

(21) Appl. No.: 16/177,947

(22) Filed: Nov. 1, 2018

Related U.S. Application Data
(62) Division of application No. 14/887,377, filed on Oct. 20, 2015.

(30) Foreign Application Priority Data
Oct. 24, 2014 (JP) 2014-217152

(51) Int. Cl. H01M 4/86; H01M 4/90; H01M 8/1004; H01M 8/1018

(52) U.S. Cl. CPC H01M 4/8663; H01M 4/9075; H01M 2008/1095; H01M 8/1004; Y02P 70/56; H01M 4/9041

(57) ABSTRACT

A catalyst electrode layer is configured to be disposed in contact with an electrolyte membrane of a fuel cell. A content of Fe per unit area of the catalyst electrode layer is equal to or larger than 0 μg/cm² and equal to or smaller than 0.14 μg/cm², and a water absorption rate of the catalyst electrode layer is equal to or higher than 11% and equal to or lower than 30%.

### INCORPORATION BY REFERENCE

The disclosure of Japanese Patent Application No. 2014-217152 filed on Oct. 24, 2014 including the specification, drawings and abstract is incorporated herein by reference in its entirety.

### BACKGROUND OF THE INVENTION

### 1. Field of the Invention

The invention relates to a catalyst electrode layer, a membrane-electrode assembly, and a fuel cell.

### 2. Description of Related Art

A membrane-electrode assembly used in a polymer electrolyte fuel cell includes a proton-conducting polymer electrolyte membrane, and an anode and a cathode that are catalyst electrode layers provided on the electrolyte membrane. In the fuel cell, hydrogen or oxygen supplied to the membrane-electrode assembly may pass through the electrolyte membrane without being used for a power generation reaction, and may move to the electrode opposite to the electrode to which the hydrogen or oxygen is supplied. In this case, hydrogen peroxide (H₂O₂) may be generated at the electrode side where there are hydrogen and oxygen. It is known that the catalyst electrode layer is deteriorated by hydrogen peroxide radicals generated from hydrogen peroxide. Thus, Japanese Patent Application Publication No. 2013-069534 (JP 2013-069534 A) describes a fuel cell including a separator in which a humidifying passage for supplying water to a catalyst electrode layer is formed in order to discharge generated hydrogen peroxide radicals using the water.

However, there is room for improvement in the technology for suppressing the deterioration of the catalyst electrode layer. The inventors of the invention have found that, in order to improve the durability of the membrane-electrode assembly, it is more preferable to make the water absorption ability of the catalyst electrode layer fall within a prescribed range, in addition to forming the fuel cell such that the catalyst electrode layer is maintained in a moist state during power generation of the fuel cell as in the above-mentioned related art.

### SUMMARY OF THE INVENTION

An aspect of the invention relates to a catalyst electrode layer configured to be disposed in contact with an electrolyte membrane of a fuel cell. A content of Fe per unit area of the catalyst electrode layer is equal to or larger than 0 μg/cm² and equal to or smaller than 0.14 μg/cm², and a water absorption rate of the catalyst electrode layer is equal to or higher than 11% and equal to or lower than 30%. The water absorption rate satisfies a relationship of the water absorption rate=(Q3−Q1)/Q1×100−(Q2−Q1)/Q1×100, where Q1 is a weight of the catalyst electrode layer after the catalyst electrode layer is dried for 1 hour under an environment in which a temperature is 100° C. and a relative humidity is 0%, after a fuel cell including the catalyst electrode layer is maintained for 100 hours under a condition that a cell temperature is 60° C., the relative humidity is 40%, and a generated voltage is 0.5 V, Q2 is a weight of the catalyst electrode layer after the catalyst electrode layer is further maintained for 1 hour under an environment in which the temperature is 70° C. and the relative humidity is 15%, and Q3 is a weight of the catalyst electrode layer after the catalyst electrode layer is further maintained for 1 hour under an environment in which the temperature is 70° C. and the relative humidity is 90%. With this configuration, it is possible to improve the durability of the catalyst electrode layer.

The invention may be implemented in various aspects. For example, the invention may be implemented as a membrane-electrode assembly including the catalyst electrode layer, a fuel cell including the membrane-electrode assembly, and production methods thereof, and further, a production method for the membrane-electrode assembly including the above-mentioned testing method.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an explanatory diagram showing a schematic configuration of a fuel cell according to an embodiment of the invention;

FIG. 2 is a flowchart showing a production process for a membrane-electrode assembly according to the embodiment;

FIG. 3 is a relationship diagram showing a relationship between a water absorption rate and a performance decrease rate with regard to samples #1 to #11;

FIG. 4 is a relationship diagram showing a relationship between the water absorption rate and a cell resistance with regard to the samples #1 to #6, and #9 to #11;

FIG. 5 is a relationship diagram showing a relationship between the water absorption rate and an ionomer decomposition rate with regard to the samples #1 to #6, and #9 to #11;

FIG. 6 is a relationship diagram showing a relationship between the water absorption rate and a content of Fe with regard to the samples #3 to #6, and #9 to #11;

FIG. 7 is a relationship diagram showing a relationship between the water absorption rate and a relative humidity with regard to the samples #1 to #6, and #9;

FIG. 8 is a relationship diagram showing a relationship between the water absorption rate and a gas diffusion resistance with regard to the samples #3 to #9; and

FIG. 9 is a relationship diagram showing a relationship between the water absorption rate and the performance decrease rate with regard to the samples #12 to #16.

### DETAILED DESCRIPTION OF EMBODIMENTS

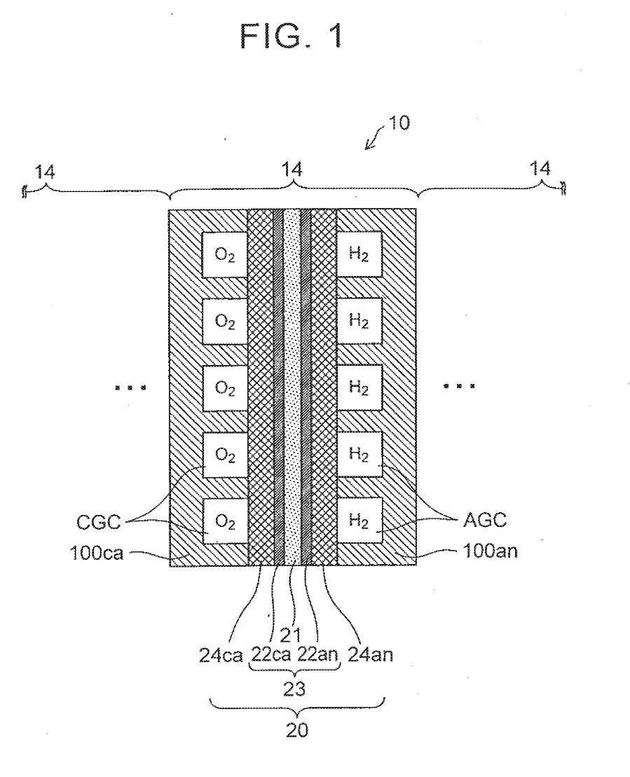

FIG. 1 is an explanatory diagram showing a schematic configuration of a fuel cell 10 according to an embodiment of the invention. The fuel cell 10 is a polymer electrolyte fuel cell. The fuel cell 10 has a stack structure in which a plurality of unit cells 14 are stacked. In the fuel cell 10, each unit cell 14 is a unit module that generates electric power. The unit cell 14 generates electric power by using an electrochemical reaction between hydrogen gas and oxygen contained in air. Each unit cell 14 includes a power generation body 20, and paired separators 100 (an anode-side separator 100an, and a cathode-side separator 100ca). The power generation body 20 is sandwiched between the separators 100. The power generation body 20 includes a membrane-electrode assembly (MEA) 23, and paired gas diffusion layers 24 (an anode-side diffusion layer 24an and a cathode-side diffusion layer 24ca) that are disposed on respective sides of the membrane-electrode assembly 23. The membrane-electrode assembly 23 includes an electrolyte membrane 21, and catalyst electrode layers 22 (an anode 22an and a cathode 22ca) provided on respective surfaces of the electrolyte membrane 21.

The electrolyte membrane 21 is a proton-conducting ion-exchange membrane formed of, for example, a fluorine resin. The electrolyte membrane 21 exhibits good electric conductivity in a moist condition. As the electrolyte membrane 21, for example, a solid polymer electrolyte membrane formed of a perfluorosulfonic acid polymer that has at least one sulfo group (—SO₃H group) at a side chain end may be used. More specifically, as the electrolyte membrane 21, for example, a fluorine-based sulfonic acid membrane, such as a Nafion membrane (117, Nafion is a registered trademark), Aciplex (a registered trademark), or Flemion (a registered trademark), may be used.

The anode 22an of the catalyst electrode layers 22 functions as an anode electrode when the fuel cell 10 generates electric power. The cathode 22ca of the catalyst electrode layers 22 functions as a cathode electrode when the fuel cell 10 generates electric power. For example, each of the catalyst electrode layers 22 may include carbon particles (a catalyst support) supporting catalyst metal (for example, platinum) that promotes the electrochemical reaction, and a proton-conducting polymer electrolyte (ionomer). As the ionomer, for example, a perfluorosulfonic acid polymer that has at least one sulfo group (—SO₃H group) at the side chain end may be used. The ionomer included in the catalyst electrode layer 22 may the same polymer as the ionomer included in the electrolyte membrane 21, or a polymer different from the ionomer included in the electrolyte membrane 21. As the conductive support (as the catalyst support), for example, carbon materials such as carbon black, carbon nanotube, and carbon nanofiber, and carbon compounds such as silicon carbide may be used, in addition to the carbon particles. As the catalyst metal, for example, platinum-alloy, palladium, rhodium, gold, silver, osmium, and iridium may be used, in addition to platinum.

Each of the catalyst electrode layers 22 is preferably configured such that the water absorption rate of the catalyst electrode layer 22 is equal to or higher than 11% and equal to or lower than 30% (i.e., the water absorption rate is 11% to 30%). The water absorption rate is a value indicating the water-absorbing performance of the catalyst electrode layer. In the case where the water absorption rate of the catalyst electrode layer 22 is equal to or higher than 11%, even if hydrogen peroxide is generated due to cross leakage or the like, the generated hydrogen peroxide can be discharged by water contained in the catalyst electrode layer 22. Therefore, decomposition of the ionomer due to the hydrogen peroxide is suppressed. Further, in the case where the water absorption rate is equal to or lower than 30%, it is possible to suppress a decrease in the efficiency in supplying the gas to the catalyst due to closure of pores of the catalyst electrode layer 22 caused by swelling of the ionomer.

The amount of water absorbed into the catalyst electrode layer 22 varies even under the same humidity environment (moisture environment), depending on, for example, the properties of molecules constituting the ionomer. More specifically, the molecules constituting the ionomer include a perfluorocarbon-based main chain, and at least one side chain having a sulfo group (—SO₃H group) at the end thereof. In this case, the amount of water absorbed into the catalyst electrode layer 22 varies even under the same humidity environment, depending on, for example, the number of the sulfo groups (—SO₃H groups) in the side chains, and the rigidity of the main chain. The water absorption rate of the catalyst electrode layer 22 is influenced by (varies depending on) the kind and weight percent of the ionomer in the catalyst electrode layer 22, the kind and weight percent of the carbon (the catalyst support) in the catalyst electrode layer, and the structure of the catalyst electrode layer. For example, with regard to the ionomer, as the amount of sulfonic acid increases, the water absorption rate increases, and as the crystallinity increases, the water absorption rate decreases. For example, with regard to the carbon, as the surface area or the pore volume increases, the water absorption rate increases. Further, for example, with regard to the catalyst layer structure, as the thickness increases, the water absorption rate increases. By adjusting these factors, the water absorption rate of the catalyst electrode layer 22 can be set to a value in the above-mentioned range.

The water absorption rate of the catalyst electrode layer 22 is calculated by the method described below. First, the fuel cell including the membrane-electrode assembly in which the catalyst electrode layers 22 are formed is maintained for 100 hours under the condition that the cell temperature is 60° C., the relative humidity is 40%, and the generated voltage is 0.5 V. Then, the catalyst electrode layer 22 is scraped out from (taken out from) the membrane-electrode assembly, and is dried for 1 hour under the environment in which the temperature is 100° C. and the relative humidity (RH) is 0%, and then, a weight Q1 of the catalyst electrode layer 22 is measured. Next, the catalyst electrode layer 22 is maintained for 1 hour under the environment in which the temperature is 70° C. and the relative humidity (RH) is 15%, and then, a weight Q2 of the catalyst electrode layer 22 is measured. Further, the catalyst electrode layer 22 is maintained for 1 hour under the environment in which the temperature is 70° C. and the relative humidity (RH) is 90%, and then, a weight Q3 of the catalyst electrode layer 22 is measured. By using the expression (1) described below, the water absorption rate of the catalyst electrode layer 22 is calculated from the measured weights Q1, Q2, and Q3.

Water absorption rate=(Q3−Q1)/Q1×100−(Q2−Q1)/Q1×100 (1)

Iron (Fe) may be mixed into the catalyst electrode layer 22 depending on a production process or the like. In this case, it is preferable that the content of Fe should be equal to or larger than 0 μg/cm² and equal to or smaller than 0.14 μg/cm² (i.e., the content of Fe should be 0 μg/cm² to 0.14 μg/cm²). In the case where the content of Fe is in the above-mentioned range, even if hydrogen peroxide is generated, the ionomer is unlikely to be decomposed by the generated hydrogen peroxide, as compared to the case where the content of Fe in the catalyst electrode layer is larger than 0.14 μg/cm².

The gas diffusion layers 24 are layers in which the reaction gas used in electrode reactions (i.e., anode gas and cathode gas) is diffused along a planar direction of the electrolyte membrane 21. Each of the gas diffusion layers 24 is formed of a porous gas diffusion layer base material. As the gas diffusion layer 24, for example, a carbon porous body formed of carbon paper or carbon cloth may be used. A water-repellent layer may be formed in the gas diffusion layer 24 such that the gas diffusion layer 24 has a water-repellent property, by coating the gas diffusion layer base material with water-repellent paste (i.e., by performing water-repellent treatment on the gas diffusion layer base material). As the water-repellent paste, for example, a mixed solution of carbon powder and a water-repellent resin (for example, polytetrafluoroethylene (PTFE), polyethylene, or polypropylene) may be used.

Each of the separators 100 is formed of a member that has a gas barrier property and electron conductivity. For example, the separator 100 is formed using a carbon member made of, for example, dense carbon that is made gas-impermeable by compressing carbon, or a metal member that is made of stainless steel or the like, and that is formed by a pressing process. Protrusions and recesses are provided on the surface of the separator 100 so as to form flow passages through which the gas and liquid flow. Anode gas passages AGC are formed between the anode-side separator 100an and the anode-side diffusion layer 24an. Cathode gas passages CGC are formed between the cathode-side separator 100ca and the cathode-side diffusion layer 24ca.

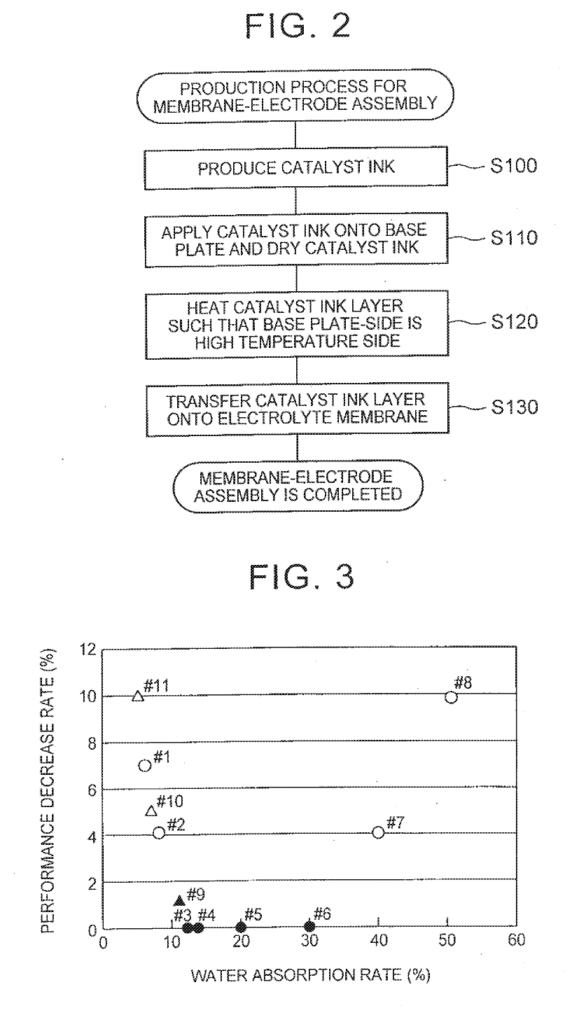

FIG. 2 is a flowchart showing a production process for the membrane-electrode assembly 23 according to the embodiment. In order to produce the membrane-electrode assembly 23, first, catalyst ink is produced (step S100). More specifically, an ionomer that is a perfluorosulfonic acid polymer that has at least one sulfo group (—SO₃H groups) at the side chain end, and catalyst-supporting carbon are prepared. Then, the ionomer and the catalyst-supporting carbon are dispersed in an aqueous solution of a solvent (for example, alcohol) to produce the catalyst ink. The operation of dispersing the ionomer and the catalyst-supporting carbon in step S100 is not particularly limited, as long as the ionomer and the catalyst-supporting carbon can be sufficiently dispersed in the solvent. For example, processes such as a stirring process and an ultrasonic process may be appropriately combined.

The catalyst-supporting carbon can be produced, for example, by dispersing carbon particles made of carbon black in a solution of a platinum compound, and performing an impregnating process, a coprecipitation process, or an ion exchange process. As the solution of the platinum compound, for example, a solution of a tetraammine platinum salt, a solution of dinitrodiammine platinum, a solution of a platinum nitrate, or a solution of a chloroplatinic acid may be used. For example, the amount of the catalyst-supporting carbon mixed with the ionomer is in a range such that the weight ratio of the ionomer with respect to the catalyst-supporting carbon is 0.5 to 1.2.

After step S100, the produced catalyst ink is applied onto a base plate, and is dried (step S110). The base plate is not particularly limited, as long as a membrane can be formed by applying the catalyst ink onto the base plate. The base plate may be a thin membrane formed of, for example, polyethylene terephthalate (PET) or polytetrafluoroethylene (PTFE). The method of applying the catalyst ink in step S110 is not particularly limited. For example, a spray method, a screen printing method, a doctor blade method, or a die coating method may be employed. By applying the catalyst ink onto the base plate, and drying the catalyst ink, the solvent in the catalyst ink vaporizes, and thus, the layer of the catalyst ink (the catalyst ink layer) becomes a porous layer.

Then, the catalyst ink layer on the base plate is heated such that a base plate-side of the catalyst ink layer (i.e., a side of the catalyst ink layer, which is in contact with the base plate) is a high temperature side (step S120). More specifically, heating is performed such that the temperature of the base plate-side of the catalyst ink layer is a first temperature that is set in advance, and the temperature of a side of the catalyst ink layer, which is not in contact with the base plate, is a second temperature lower than the first temperature, that is, a temperature gradient is provided within the catalyst ink layer.

The catalyst ink layer heated in step S120 is transferred onto the electrolyte membrane (step S130), and thus, the membrane-electrode assembly is completed. The catalyst ink layer may be transferred onto the electrolyte membrane, for example, by hot pressing while a surface of the catalyst ink layer, on which the base plate is not provided, is in contact with the electrolyte membrane. After the catalyst ink layer is transferred onto the electrolyte membrane, the base plate is separated (removed) from the catalyst ink layer. Thus, the cathode is formed on the electrolyte membrane.

In the embodiment, the anode is formed on the electrolyte membrane by applying the catalyst ink that is the same as or similar to the catalyst ink used to form the cathode, onto a base plate, and transferring the catalyst ink layer onto the electrolyte membrane without performing heating in step S120. The anode may be formed by transferring the catalyst ink layer onto the electrolyte membrane before step S130. Alternatively, the anode may be formed by transferring the catalyst ink layer onto the electrolyte membrane in step S130 after the cathode is formed by transferring the catalyst ink layer onto the electrolyte membrane.

In order to confirm the effect in the embodiment, sixteen samples #1 to #16 of the membrane-electrode assembly were prepared, and durability evaluation was performed on the catalyst electrode layer included in each sample. (1) Each of the samples #1 to #8 was produced as described below. A catalyst was produced, catalyst ink was produced using the catalyst, a catalyst electrode layer was produced using the catalyst ink, and a membrane-electrode assembly (MEA) was produced using the catalyst electrode layer.

(Production of catalyst powder) As carbon for supporting the catalyst, acetylene black-based carbon was used. The acetylene black-based carbon had the surface area of 850 m²/g, the primary particle size of 12 nm, the bulk density of 0.02/ml, the crystal size (La) of 20 nm, the iodine adsorption amount of 870 mg/g, and the dibutyl phthalate oil absorption (DBP oil absorption) of 280 ml/g. Then, 5.0 g of the acetylene black-based carbon was added to 1.2 L of pure water, and was dispersed in the pure water to produce a dispersion solution. A hexahydroxo platinum nitrate solution containing 5.0 g of platinum, and a cobalt nitrate aqueous solution containing 0.21 g of cobalt were dropped into the dispersion solution, and were sufficiently stirred with the carbon. Then, after the dispersion solution was stirred, approximately 100 ml of 0.1N ammonia was added to the dispersion solution to achieve a pH of approximately 10. Thus, hydroxide was formed and was deposited on the carbon. The dispersion solution was filtered to obtain powder, and the obtained powder was dried under vacuum at 100° C. for 10 hours. Next, a reduction process was performed while the powder was maintained at 400° C. for 2 hours in hydrogen gas. Then, the powder was maintained at 1000° C. for 10 hours in nitrogen gas to produce alloy powder. Thus, catalyst powder was obtained. The catalyst powder was stirred in 1.0N nitric acid for 2 hours. In the composition of the obtained catalyst, Pt was 49 wt %, Co was 2 wt %, and C was 49 wt %. The average particle size of PtCo was 4 nm.

(Production of catalyst ink) Then, 10 ml of ultrapure water was added to 1 g of the produced catalyst powder, and stirring was performed. Then, 5 ml of ethanol was added, and stirring was performed with the use of a stirring rod to obtain a suspension in which particles were in a fully suspended state. Then, an ionomer solution with an equivalent weight (EW) of 910 as an ion conductor was slowly dropped into the suspension until the weight ratio of the solid content of the ionomer solution to the carbon in the catalyst (hereinafter, referred to as “I/C”) became 1.0, and was dispersed for 30 minutes with the use of an ultrasonic dispersion device to obtain uniform slurry. Thus, the catalyst ink as the catalyst electrode material was produced.

(Production of catalyst electrode layer) The produced catalyst ink was uniformly applied onto a sheet of Teflon (a registered trademark) with the use of a squeegee such that the weight of platinum per unit area of the catalyst was 0.3 mg/cm². After the catalyst ink was applied onto the Teflon sheet, the Teflon sheet was dried at 80° C. for 3 hours, and thus, the catalyst electrode layer was produced.

(Production of membrane-electrode assembly) Nafion (the registered trademark) 117 was used as the solid polymer electrolyte membrane, and the produced catalyst electrode layer was used as each of the anode and cathode. While the solid polymer electrolyte membrane was sandwiched between the anode and the cathode, hot pressing was performed at 170° C. for 300 seconds. Thus, the membrane-electrode assembly was produced.

(Durability test) The produced membrane-electrode assembly was sandwiched between gas diffusion layer base materials each of which was formed of carbon fiber and a water-repellent layer. H₂ was supplied to the anode, and air was supplied to the cathode, and current-voltage characteristics (i.e., I-V characteristics) were measured at the cell temperature of 60° C. The current value (A) at the cell voltage of 0.5 V was regarded as initial performance (performance before a durability test). Then, the durability test was conducted. More specifically, electric power was generated by the samples #1 to #8 under the same condition for 100 hours. The relative humidities (%) of the samples #1 to #8 during the durability test were described below. The relative humidity was measured at a gas supply port on the cathode side. Since the relative humidities of the samples #1 to #8 during the durability test were made different from each other, the water absorption rates of the samples #1 to #8 were made different from each other. The relative humidities of the samples #1 to #8 during the durability test were made different from each other, in order to easily simulate the difference in the water absorption rate (the water absorption performance) due to the difference in the composition of the catalyst electrode layer. Actually, the water absorption rate can be adjusted by adjusting the composition of the catalyst electrode layer. The relative humidity of the sample #1 was 20%, the relative humidity of the sample #2 was 30%, the relative humidity of the sample #3 was 40%, the relative humidity of the sample #4 was 60%, the relative humidity of the sample #5 was 80%, the relative humidity of the sample #6 was 100%, the relative humidity of the sample #7 was 130%, and the relative humidity of the sample #8 was 200%.

(2) Each of the samples #9 to #11 was produced as described below. When the catalyst ink was produced, iron (III) nitrate was added, and thus, the catalyst electrode layer was produced such that the catalyst electrode layer contained Fe. Thus, the catalyst electrode layer was produced. The content of Fe per unit area of the catalyst electrode layer in each of the samples #9 to #11 was as described below. The other production conditions were the same as those used when the samples #1 to #8 were produced. The relative humidity during the durability test was 40% as in the case of the sample #3. The content of Fe in the sample #9 was 0.14 μg/cm², the content of Fe in the sample #10 was 0.28 μg/cm², and the content of Fe in the sample #11 was 0.56 μg/cm².

(3) Each of the samples #12 to #16 was produced as described below. The samples #12 to #16 are different from the samples #1 to #8 in the following points. The relative humidity during the durability test was 40% as in the case of the sample #3. With regard to the sample #12, tetrahydrofuran was added instead of ethanol in the process of producing the catalyst ink. With regard to the sample #13, acetone was added instead of ethanol in the process of producing the catalyst ink. With regard to the sample #14, the Teflon sheet, to which the catalyst ink was applied, was dried under vacuum of −200 mmHg in the process of producing the catalyst electrode layer. With regard to the sample #15, ethanol was not added in the process of producing the catalyst ink. With regard to the sample #16, a fluorine-based solvent with a high boiling point (ASAHIKLIN AC-6000 produced by Asahi Glass Co., Ltd.) was added instead of water and ethanol, in the process of producing the catalyst ink.

(Durability performance evaluation) After the above-mentioned durability test, the I-V characteristics were measured, and the current value (A) at the cell voltage of 0.5 V was regarded as the performance after the durability test. A performance decrease rate was calculated from the measured initial performance and the measured performance after the durability test, using the expression (2) described below. Further, the impedance at the frequency of 1000 Hz was measured as a cell resistance (Ω·cm²), with the use of a Frequency Response Analyzer (FRA).

Performance decrease rate=(initial performance−performance after durability test)/initial performance×100 (2)

(Physical property (water absorption rate)) After the above-mentioned durability test, the cathode catalyst electrode layer was scraped out (taken out) from each sample, and the weight Q1, the weight Q2, and the weight Q3 were measured. In addition, the water absorption rate (%) of the catalyst electrode layer of each sample was calculated using the above-mentioned expression (1).

(Physical property (ionomer decomposition rate)) Heating was performed on the cathode catalyst electrode layer, which was taken out from each sample, in the stream of N₂ such that the temperature increased to 500° C. at the increase rate of 1° C./min. The amount of desorbed sulfur (S) components of the ionomer was measured with the use of a mass analyzer. The ionomer decomposition rate (%) was measured based on the ratio between the amount of S components before the durability test and the amount of S components after the durability test, as indicated by the expression (3) described below.

Ionomer decomposition rate=(the amount of S components before durability test−the amount of S components after durability test)/the amount of S components after durability test×100 (3)

(Physical property (gas diffusion resistance)) With regard to each sample after the durability test, the I-V characteristics were measured while the relative humidity was set to 30%, and the reaction gas was supplied such that the oxygen concentration was low. The limiting current (A) was measured based on the obtained I-V characteristics. The limiting current is a current in a portion in which the current does not increase with a decrease in the voltage, in the I-V characteristics. The gas diffusion resistance (sec/m) was calculated from the measured limiting current, using the expression (4) described below.

Gas diffusion resistance=O₂ partial pressure (Pa)×Faraday constant×power generation area (cm²)/8.31×temperature (K)×limiting current (A) (4)

FIG. 3 is a relationship diagram showing a relationship between the water absorption rate (%) and the performance decrease rate (%) with regard to the samples #1 to #11. With regard to the samples #3 to #6, and #9 whose water absorption rates were equal to or higher than 11% and equal to or lower than 30%, the performance decrease rates were equal to or lower than 1%. In contrast, with regard to the samples #1, #2, #10 and #11, whose water absorption rates were equal to or lower than 8%, and the samples #7 and #8 whose water absorption rates were equal to or higher than 40%, the performance decrease rates were equal to or higher than 4%. Based on the results, it has been found that when the water absorption rate of the catalyst electrode layer is equal to or higher than 11% and equal to or lower than 30% (i.e., the water absorption rate is in a range of 11% to 30%), the durability of the catalyst electrode layer is increased, as compared to when the water absorption rate is outside the range.

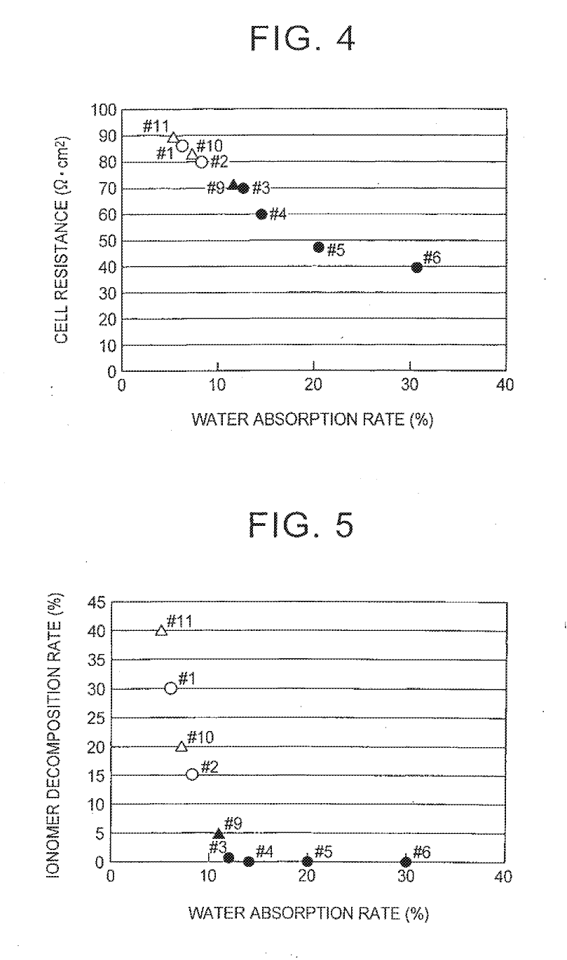

FIG. 4 is a relational diagram showing a relationship between the water absorption rate (%) and the cell resistance (Ω·cm²) with regard to the samples #1 to #6, and #9 to #11. Based on the results regarding the samples #1 to #6, and #9 to #11, it has been found that in a range where the water absorption rate is equal to or lower than 30%, as the water absorption rate increases, the cell resistance decreases. Thus, it has been found that when the water absorption rate of the catalyst electrode layer is equal to or higher than 11%, the cell resistance is decreased, as compared to when the water absorption rate is lower than 11%.

FIG. 5 is a relationship diagram showing a relationship between the water absorption rate (%) and the ionomer decomposition rate (%) with regard to the samples #1 to #6, and #9 to #11. Based on the results regarding the samples #1 to #6, and #9 to #11, it has been found that in the range where the water absorption rate is equal to or lower than 30%, as the water absorption rate increases, the ionomer decomposition rate decreases. This reason is considered to be that as the water absorption rate of the catalyst electrode layer becomes higher, the decomposition of the ionomer due to hydrogen peroxide generated during the durability test is more suppressed. Thus, it has been found that when the water absorption rate of the catalyst electrode layer is equal to or higher than 11%, the ionomer decomposition rate is decreased, as compared to when the water absorption rate is lower than 11%.

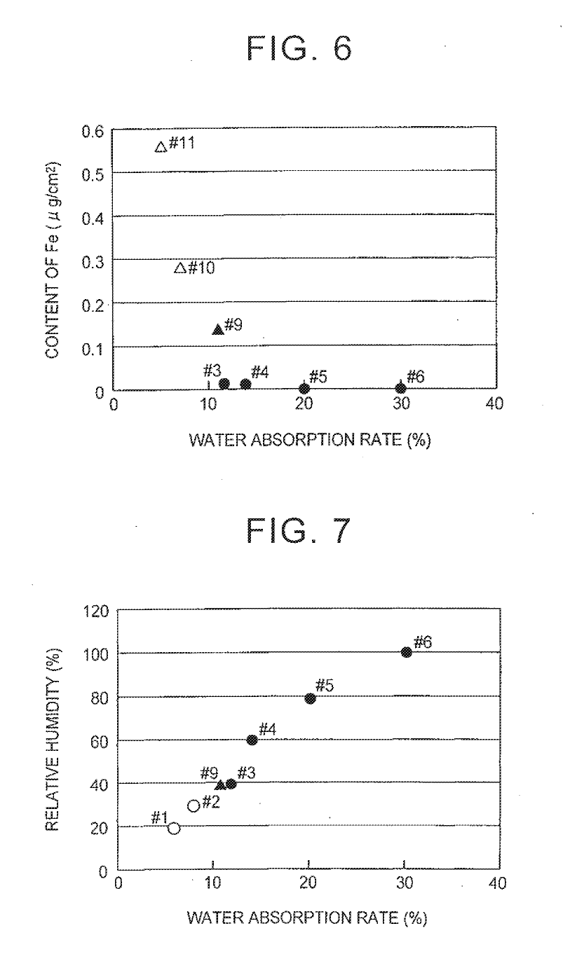

FIG. 6 is a relationship diagram showing a relationship between the water absorption rate (%) and the content of Fe (μg/cm²) with regard to the samples #3 to #6, and #9 to #11. Based on the results regarding the samples #3, and #9 to #11, it has been found that even when the relative humidity during the durability test is the same (40% RH), as the content of Fe in the catalyst electrode layer increases, the water absorption rate of the catalyst electrode layer decreases. The reason is considered to be that the decomposition of the ionomer due to hydrogen peroxide is promoted by Fe contained in the catalyst electrode layer. Thus, it has been found that the content of Fe in the catalyst electrode layer is preferably equal to or larger than 0 μg/cm² and equal to or smaller than 0.14 μg/cm²

FIG. 7 is a relationship diagram showing a relationship between the water absorption rate (%) and the relative humidity (%) with regard to the samples #1 to #6, and #9. Based on the results regarding the samples #1 to #6, it has been found that as the relative humidity during the durability test decreases, the water absorption rate of the catalyst electrode layer decreases. The reason is considered to be that as the relative humidity during the durability test becomes lower, the ionomer is more likely to be decomposed due to hydrogen peroxide during the durability test. Thus, it has been found that it is preferable to set the relative humidity to 40% during the durability test, rather than setting the relative humidity to a value lower than 40%. Further, it is more preferable to maintain a membrane-electrode assembly for 100 hours under the condition that the cell temperature is 60° C., the relative humidity is 40%, and the generated voltage is 0.5 V during the durability test.

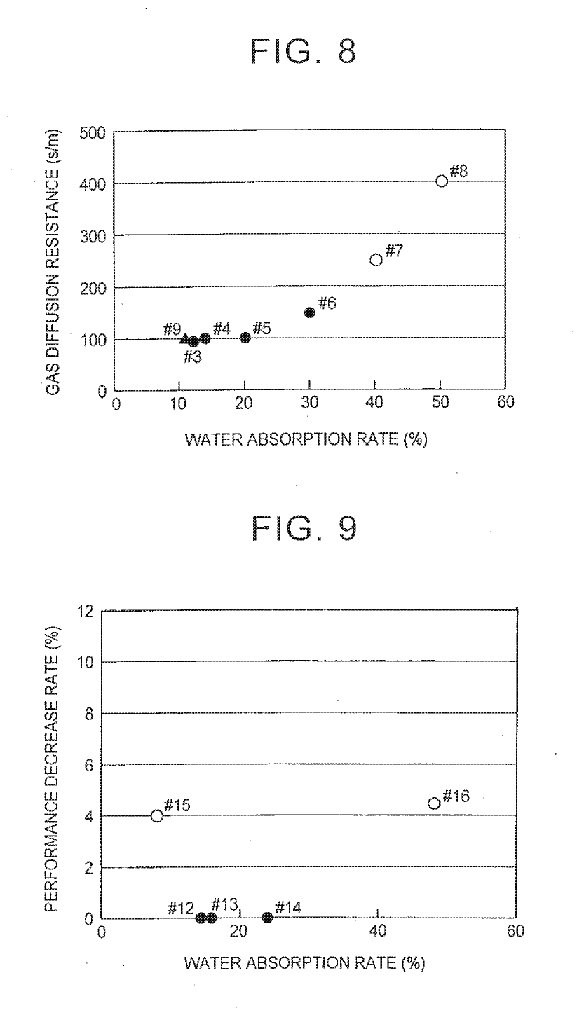

FIG. 8 is a relationship diagram showing a relationship between the water absorption rate (%) and the gas diffusion resistance (sec/m) with regard to the samples #3 to #9. Based on the results regarding the samples #3 to #9 whose water absorption rates were equal to or higher than 10%, it has been found that as the water absorption rate of the catalyst electrode layer increases, the gas diffusion resistance increases. The reason is considered to be that as the water absorption rate of the catalyst electrode layer becomes higher, flooding is more likely to occur due to water retained in the catalyst electrode layer as a result of swelling of the ionomer. Thus, it has been found that when the water absorption rate of the catalyst electrode layer is equal to or lower than 30%, the gas diffusion resistance is decreased, as compared to when the water absorption rate is higher than 30%.

FIG. 9 is a relationship diagram showing a relationship between the water absorption rate (%) and the performance decrease rate (%) with regard to the samples #12 to #16. With regard to the samples #12 to #14 whose water absorption rates were equal to or higher than 11% and equal to or lower than 30%, the performance decrease rates were substantially 0%. In contrast, with regard to the sample #15 whose water absorption rate was 8%, and the sample #16 whose absorption rate was 48%, the performance decrease rate was 4%. Thus, it has been found that when the water absorption rate of the catalyst electrode layer is equal to or higher than 11% and equal to or lower than 30% (i.e., the water absorption rate is in the range of 11% to 30%), the durability of the catalyst electrode layer is increased as compared to when the water absorption rate is outside the range. Further, based on the results regarding the samples #12 to #16, it has been found that the water absorption rate of the catalyst electrode layer is correlated with the durability of the catalyst electrode layer, regardless of the relative humidity during the durability test, the materials, and the production conditions.

Thus, it is considered that high durability (excellent durability) can be obtained by controlling the water absorption rate of the catalyst electrode layer such that the water absorption rate is in the specified range. More specifically, as evident from the results regarding the samples #1 to #11 shown in FIG. 3, it is preferable that the water absorption rate of the catalyst electrode layer should be controlled to be equal to or higher than 11% and equal to or lower than 30% (the water absorption rate should be controlled to be in the range of 11% to 30%) and the content of Fe in the catalyst electrode layer should be controlled to be equal to or larger than 0 μg/cm² and equal to or smaller than 0.14 μg/cm² (the content of Fe should be controlled to be in the range of 0 μg/cm² to 0.14 μg/cm²). When the water absorption rate of the catalyst electrode layer and the content of Fe in the catalyst electrode layer are controlled in the above-mentioned manner, the durability of the catalyst electrode layer can be improved.

The invention is not limited to the above-mentioned embodiment, and may be implemented in various modes without departing from the scope of the invention. For example, the invention may be implemented in modified examples described below.

(First Modified Example) In the above-mentioned embodiment, the catalyst electrode layer whose water absorption rate is 11% to 30%, and whose content of Fe is 0 μg/cm² to 0.14 μg/cm² is used as each of the anode 22an and the cathode 22ca. However, only one of the anode 22an and the cathode 22ca may be constituted by the above-mentioned catalyst electrode layer. In this case as well, the durability of the catalyst electrode layer can be improved. It is preferable that both of the anode 22an and the cathode 22ca should be constituted by the above-mentioned catalyst electrode layers.

(Second Modified Example) The invention may be implemented as a testing method for the membrane-electrode assembly. For example, in the testing method for the membrane-electrode assembly 23 including the catalyst electrode layers 22 as shown in FIG. 1, the fuel cell 10 including the membrane-electrode assembly 23 is prepared, and the durability test is conducted on the fuel cell 10 under the condition that the cell temperature is 60° C. and the relatively humidity is 40%. By testing the fuel cell 10 in this manner, it is possible to reduce deterioration of the membrane-electrode assembly after the test. More specifically, as evident from the results shown in FIG. 7, when the relative humidity during the durability test is 40%, the water absorption rate of the catalyst electrode layer is in the range of 11% to 30%. Thus, it has been found that it is preferable to set the relative humidity during the durability test to 40% such that the water absorption rate of the catalyst electrode layer after the test is equal to or higher than 11% and equal to or lower than 30%. Thus, by conducting the durability test during testing, it is possible to suppress deterioration of the membrane-electrode assembly. The cell temperature during testing is not particularly limited. However, it is preferable that the cell temperature should be 60° C. The test time period during which the durability test is conducted is not particularly limited. However, it is preferable that the test time period should be 100 hours.

1-4. (canceled)

5. A production method for a membrane-electrode assembly including a catalyst electrode layer configured to be disposed in contact with an electrolyte membrane of a fuel cell, wherein the catalyst electrode layer includes catalyst metal, a catalyst support that supports the catalyst metal, and an ionomer, the production method comprising:
adjusting at least one factor of the catalyst electrode layer such that a water absorption rate of the catalyst electrode layer is equal to or higher than 11% and equal to or lower than 30%, wherein:
the at least one factor includes at least one of a kind of the ionomer, a weight percent of the ionomer in the catalyst electrode layer, a kind of the catalyst support, a weight percent of the catalyst support in the catalyst electrode layer, and a structure of the catalyst electrode layer, and
the water absorption rate satisfies a relationship of the water absorption rate=(Q3−Q1)/Q1×100−(Q2−Q1)/Q1×100, where Q1 is a weight of the catalyst electrode layer after the catalyst electrode layer is dried for 1 hour under an environment in which a temperature is 100° C. and a relative humidity is 0%, after a fuel cell including the catalyst electrode layer is maintained for 100 hours under a condition that a cell temperature is 60° C., the relative humidity is 40%, and a generated voltage is 0.5 V, Q2 is a weight of the catalyst electrode layer after the catalyst electrode layer is further maintained for 1 hour under an environment in which the temperature is 70° C. and the relative humidity is 15%, and Q3 is a weight of the catalyst electrode layer after the catalyst electrode layer is further maintained for 1 hour under an environment in which the temperature is 70° C. and the relative humidity is 90%.

6. The production method according to claim 5, wherein the catalyst metal is platinum, platinum-alloy, palladium, rhodium, gold, silver, osmium, or iridium.

7. The production method according to claim 5, wherein the catalyst support that supports the catalyst metal comprises carbon particles, carbon black, carbon nanotube, carbon nanofiber, or silicon carbide.

8. The production method according to claim 5, wherein the ionomer is a perfluorosulfonic acid polymer that has at least one sulfa group at the side chain end.

9. The production method according to claim 6, wherein the catalyst metal is platinum.

10. The production method according to claim 7, wherein the catalyst support that supports the catalyst metal comprises carbon particles.
